(19) United States
(12) Patent Application Publication
(10) Pub. No.: US 2026/0240140 A1
(43) Pub. Date: Aug. 20, 2026

(54) FIELD-SPECIFIC SCLEROTINIA RISK ASSESSMENT

(71) Applicant: BASE SE, Ludwigshafen am Rhein (DE)

(72) Inventors: Jeffrey Wayne GRIMM, Durham, NC (US); Gerald MARTENS, Mississauga (CA); Lori YARNELL, Calgary (CA)

(21) Appl. No.: 19/471,285

(22) PCT Filed: Mar. 19, 2024
(86) PCT No.: PCT/EP2024/057262

§ 371 Date: Sep. 30, 2025

Related U.S. Application Data
(60) Provisional application No. 63/456,225, filed on Mar. 31, 2023.

(30) Foreign Application Priority Data
May 31, 2023 (EP) 23176548.8

(51) Int. Cl. A01M 7/00; A01B 79/00; A01B 79/02; G01W 1/02

(52) U.S. Cl. CPC A01M 7/0014; A01B 79/005; A01B 79/02; G01W 1/02

(57) ABSTRACT

A method (M4) for determining a disease probability value, that is indicative of a probability of an infestation of crop plants (1) of a specifiable field (2) with Sclerotinia sp. fungi, including: generating (M1, S1 to S9, S20) a field condition data set indicative of a condition of a specifiable field (2), including at least one of: a row spacing indicator, a seeding rate indicator, a tillage depth indicator, a soil texture indicator, a crop varietal indicator, a disease history indicator, a crop rotation history indicator, a planting date indicator, and/or a field geolocation indicator; providing (S28) a trained data model configured to output a disease probability value determined from a field condition data set and indicative of a probability of an infestation of crop plants (1) with Sclerotinia sp. fungi; and determining (S29) by the data model a disease probability value from the generated field condition data set.

This disclosure relates to a computer-implemented method for autonomous application of a plant protecting agent for reducing and/or preventing a damage by Sclerotinia sp. fungi to crop plants of a specifiable field, preferably to Canola plants. Further, this disclosure relates to a computer-implemented method for training a data model to output a disease probability value indicative of a probability of an infestation of crop plants of a specifiable field with Sclerotinia sp. fungi. Further, this disclosure relates to a trained data model. Further, this disclosure relates to a use of a data model trained to output a disease probability value. Further, this disclosure relates to a field condition data set indicative of a condition of a specifiable field. Further, this disclosure relates to a use of a field condition data set for training a data model to output a disease probability value. Further, this disclosure relates to a computer-implemented method for determining a disease probability value indicative of a probability of an infestation of crop plants of a specifiable field with Sclerotinia sp. fungi. Further, this disclosure relates to a computer program.

When crop plants of a field are infected with Sclerotinia sp. fungi, it can happen that harvesting the infected field becomes unprofitable. While an infection with Sclerotinia sp. fungi becomes evident during late stages of fruit growth, it is not or not certainly cognizable during early flowering stages. However, present plant protecting agents against Sclerotinia sp. fungi are most effective when applied during early flowering stages. Thus, there is a need for certainty in recognizing or predicting a risk of a Sclerotinia sp. fungi infection.

Document WO 2022/200 484 A1 discloses a computer-implemented method to predict damage of crop plants of a particular species by Sclerotinia sp. fungi, wherein the crop plants grow in a particular geographic area, the method comprising: receiving current condition data in form of time-series, the current condition data relating to the particular geographic area and being collected during a monitor interval from a start time point to a present time point, wherein the current condition data comprise plant data that describes the plants growing or to be grown in the particular geographic area by a species identifier of the particular species of crop plants, the number of occurrences of the crop plant in a previous interval; and environmental data that de-scribe the environment of the particular geographic area; processing the current condition data by an artificial neural network, to provide predicted damage data, the artificial neural network obtainable by previously training it by processing historical condition data in the form of time-series in combination with historical damage data in form of expert annotations, or in combination with historical damage data in form of sensor readings.

It is therefore an object of the present disclosure to provide a means for improved assessment of a risk of a Sclerotinia sp. fungi infection.

According to one aspect of the invention, a computer-implemented method for autonomous application of a plant protecting agent for reducing and/or preventing a damage by Sclerotinia sp. fungi to crop plants, preferably to Canola plants, of a specific field is suggested. The suggested method includes generating a field condition data set, which is indicative of a condition of the specifiable field. A field condition data set includes at least one of the following field condition indicators: a) a seeding rate indicator, b) a tillage depth indicator, c) a disease history indicator, d) a crop rotation history indicator, e) a planting date indicator, and/or f) a field geolocation indicator. A seeding rate indicator is indicative of a seeding rate of the field. A tillage depth indicator is indicative of a tillage depth of the field. A disease history indicator is indicative of a history of said Sclerotinia sp. fungi of the field. A crop rotation history indicator is indicative of a crop rotation history of the field. A planting date indicator indicative of a planting date of the field. A field geolocation indicator indicative of centroid coordinates of the field. The suggested method includes providing a trained data model. The data model is configured to output a disease probability value determined from a field condition data set. A disease probability value is indicative of a probability of an infestation of crop plants of a specifiable field with said Sclerotinia sp. fungi. The data model is obtainable by previous training with multiple training data sets, wherein each training data set includes one of said field condition data sets and an associated disease indication probability value. The suggested method includes determining by the data model a disease probability value from the generated field condition data set. The suggested method includes initiating based on the determined disease probability value an application of the plant protecting agent to said field by an autonomously movable robot.

A field means an agricultural field. A field may be understood as a smallest agricultural element. A field may be determined by being homogenously planted. A field may be determined by a register, such as a land register and/or title register. A field may be delimited by an infrastructure and/or a change in planted crops including a hedgerow, a tree row and/or the like.

A field condition data set may be understood as data characteristic for a specific field, which is suitable for and/or used as input into the data model. The field condition data set may have a format suitable for the data model. The field condition data set may be understood as descriptive and/or indicative of a state of a specific field, including crops growing at this field, at a given point in time.

The above field conditions a) to f) allow for a field-specific assessment of a risk that the crop of a specific field may suffer from a Sclerotinia sp. fungi infection in the same season. Thus, this aspect offers a means for improved Sclerotinia sp. fungi risk assessment.

The above combination of the disease indication probability value for Sclerotinia sp. fungi from the trained data model with the initiation of applying the plant protecting agent by said autonomously movable robot allows for a fast reaction time to a Sclerotinia sp. fungi indication. A time window for applying the agent may be very narrow, depending on the time of indication, a crop growth dependency of the agent, a weather condition suitable for agent application, and/or so forth. Thus, an automated agent application, which results from the above combination, is beneficial in view of said possibly narrow time window.

The data model is trained by training data sets. Each training data set has a field condition data set and a disease indication probability value. Each field condition data set has at least one of the above-discussed field condition indicators a) through f), and may additionally have at least one of below-discussed field condition indicators g) to t). The disease indication probability value may preferably include an expert annotated historical data and/or a historical damage data preferably based on sensor readings.

The data model can only determine a disease probability value based on the field condition indicators, which are present in the field condition data set and on which the data model is trained. It is preferred for precision purposes, that each field condition indicator, on which the data model has been trained, is present in the field condition data set. However, this is not mandatory for ease-of-application purposes. Optionally, the data model may be provided with at least one list of required field condition indicators, and the generated field condition data set includes at least the field condition indicators according to any one of said lists. A field condition may be referred to as a field attribute.

The trained data model is preferably a machine learning model, preferably an artificial neural network, and/or preferably an expert rule model. The disease indication, which is associated to a field condition data set, preferably is an expert annotated historical damage data and/or a historical damage data based on sensor readings.

Initiating a spreading may include sending a spreading order specifying the field to be spread. The method may include controlling the autonomously movable robot, wherein said controlling may include said initiating as well as controlling a path taken and/or to be taken by the robot and/or controlling a spraying action performed and/or to be performed by the robot.

The crop rotation history indicator preferably is indicative of a rotation history of the field for the previous up to ten years, more preferable the previous up to five years, preferably the previous up to three years, and more preferably the previous up to two years. The crop rotation history indicator may include a crop history indicator for every of the previous years.

The crop rotation history indicator may be described as an indicator indicative of the specific crop species previously grown in a field. The crop rotation history indicator may be indicative of a history of canola crop plants. Examples for canola crop plants include Brassica napus and Brassica rapa. The crop rotation history indicator may be indicative of a history of pulse crop plants. A pulse crop plant is a leguminous crop, which usually is harvested for seed. Examples for pulse crop plants include peas, lentils, dry beans, and chickpeas. The crop history indicator may be indicative of a history of cereal crop plants. A cereal crop plant is a member in the grass family. Examples for cereal crop plants include wheat, barley, rye, oats, rice, and maize.

A training data set preferably includes a historical field condition data set, which preferably includes historical field condition indicators indicative of historical field conditions. Historical preferably means in this case that the data is obtained during and/or from a previous season and/or year.

According to another option, said generated field condition data set may additionally include at least one of the following field condition indicators: g) a row spacing indicator, h) a soil texture indicator, i) a crop varietal indicator, k) a precipitation indicator, l) at least one air temperature indicator, m) at least one relative humidity indicator, n) a wind speed indicator, o) a solar radiation indicator, p) a soil moisture indicator, q) a crop species indicator, r) a crop phenology indicator, s) a canopy density indicator, and/or t) a crop biomass indicator. A row spacing indicator is indicative of a crop row spacing of the field. A soil texture indicator is indicative of a soil texture of the field. A crop varietal indicator is indicative of a variety and/or maturity rating of the crop plants of the field. A precipitation indicator is indicative of a liquid accumulation of the field on a daily basis. An air temperature indicator is indicative of a characteristic value from an air temperature course of the field on a daily basis. The characteristic value from an air temperature course may preferably be a minimum air temperature of the field on a daily basis, a mean air temperature of the field on a daily basis, and/or a maximum air temperature of the field on a daily basis. A relative humidity indicator is indicative of a characteristic value from a relative humidity course of the field on a daily basis. The characteristic value from a relative humidity course may preferably be a minimum relative humidity of the field on a daily basis, a mean relative humidity of the field on a daily basis, and/or a maximum relative humidity of the field on a daily basis. A wind speed indicator is indicative of an average wind speed of the field on a daily basis. A solar radiation indicator is indicative of a solar radiation flux of the field on a daily basis. A soil moisture indicator is indicative of a moisture in an upper soil layer of the field on a daily basis. A crop species indicator is indicative of a current crop species of the field. A crop phenology indicator is indicative of a growth stage according to a phenology model of the crop of the field on a daily basis. A canopy density indicator indicative of a canopy density of the field. A crop biomass indicator indicative of a stand density of the field.

A value on a daily basis preferably is determined with a once-per-day resolution.

A depth of upper layer may depend on used sensor and/or a data supplier. The depth preferably is up to 15 cm deep, more preferably up to 11 cm deep, more preferably up to 10 cm deep, more preferably up to 8 cm deep, and even more preferably up to 7 cm deep.

The crop species indicator may be chosen from a crop species indicator indicative of Canola plants, a crop species indicator indicative of Brassica napus, and/or a crop species indicator indicative of Brassica rapa.

The crop phenology model preferably is a Xarvio phenology model for assessing BBCH growth stages on a daily basis. One preferred requirement to the crop phenology model is that it is designed to indicate crop growth stages, especially canola growth stages, on a daily basis. The crop phenology indicator may preferably be obtained via remote sensing.

The stand density may be determined from the seeding rate and the row spacing. Alternatively or additionally, the stand density may be determined based on a number of plants per row length and a row spacing.

According to another option, the above method may additionally include: requesting and receiving at least one of the field condition indicators k) to p) from at least one in-field sensor, from a remote sensing imagery and/or via a network from a data provider.

Remote sensing imagery may preferably be used for obtaining for example: a crop biomass indicator and/or a leaf area index (LAI in short), which may be used for determining a canopy density indicator.

The above indicators will be referred to throughout the remainder of this description.

It is preferred to have at least one of the field condition indicators k), l), m), n), p), s), and/or t) included in the field condition data set when a crop growth stage range is from a given timespan before BBCH 60 or from BBCH 60 to BBCH 63. It is preferred to have at least one of the field condition indicators k), l), m), and/or n) included in the field condition data set when a crop growth stage range is from BBCH 61 to BBCH 65. It is preferred to have at least one of the field condition indicators k), l), and/or m) included in the field condition data set when a crop growth stage range is from BBCH 64 to BBCH 69. It is preferred to have at least one of the field condition indicators k), l), and/or m) included in the field condition data set when a crop growth stage range is from BBCH 64 to BBCH 79. As will be explained below in greater detail, these parameters and especially their respective composition allows for a precise determination of an infestation of Canola plants with Sclerotinia sp. fungi during the respective given growth stage.

According to another aspect of the invention, a device for autonomous application of a plant protecting agent for reducing and/or preventing a damage by Sclerotinia sp. fungi to crop plants, preferably to Canola plants, is suggested. Said device has a generation means configured to generating a field condition data set, which includes at least one of the following field condition indicators: a) a seeding rate indicator, b) a tillage depth indicator, c) a disease history indicator, d) a crop rotation history indicator, e) a planting date indicator, and/or f) a field geolocation indicator. Optionally, said generated field condition data set may additionally include at least one of the following field condition indicators: g) a row spacing indicator, h) a soil texture indicator, i) a crop varietal indicator, k) a precipitation indicator, l) at least one air temperature indicator, m) at least one relative humidity indicator, n) a wind speed indicator, o) a solar radiation indicator, p) a soil moisture indicator, q) a crop species indicator, r) a crop phenology indicator, s) a canopy density indicator, and/or t) a crop biomass indicator. The suggested device includes a data model providing means configured for providing a trained data model. The suggested device includes a determination means configured for determining by the data model a disease probability value from the generated field condition data set. The suggested device includes an initiating means configured for initiating based on the received disease probability value an application of the plant protecting agent to said field by an autonomously movable robot. The generation means may include an input means configured for receiving an input from a user, and/or a communication means configured for communicating via a network with a remote computer and/or a remote sensor. The generation means may include a processor means and/or a storage means. The data model providing may include a storage means for storing the trained data model and/or a communication means for retrieving the trained data model and/or for providing access to a remotely accessible trained data model. Optionally, the suggested device may include a communication means configured for requesting and receiving at least one of the field condition indicators k) to p) from at least one in-field sensor, from a remote sensing imagery and/or via a network from a data provider. This device incorporates the features of the above method for autonomous application of a plant protecting agent, and thus has its advantages.

According to another aspect of the invention, a computer-implemented method for training a data model to output a disease probability value is suggested. The disease probability value is indicative of a probability of an infestation of crop plants of a specifiable field with Sclerotinia sp. fungi, and it is being determined from a field condition data set. The suggested method includes providing a program structure of a data model, which is configured to output a disease probability value determined from a field condition data set. Said disease probability value is indicative of a probability of an infestation of crop plants of a specifiable field with said Sclerotinia sp. fungi. The suggested method includes generating multiple training data sets. Each training data set includes one field condition data set and an associated disease indication probability value. Each field condition data set is indicative of a condition of a specifiable field. Each field condition data set includes at least one of the following field condition indicators: a) a seeding rate indicator, b) a tillage depth indicator, c) a disease history indicator, d) a crop rotation history indicator, e) a planting date indicator, and/or f) a field geolocation indicator. The suggested method includes training the data model by processing the generated training data sets, wherein a match between a disease probability value outputted in response to a query and the disease indication probability value associated with the queried field condition data set is used as a training objective.

The program structure preferably defines an act of inputting data into the data model and/or an act of outputting data from the data model. The program structure preferably defines a training algorithm applied within the data model. Thus, the suggested method for training a data model preferably is applicable to an initial training of the data model as well as to an updating and/or further training of an already trained data model.

The step of generating training data sets preferably includes colleting field condition indicator(s) and compiling associated indicator(s) into respective data sets. The step of training the data model preferably includes assimilating the generated training data set(s) into the data model.

The field condition data sets used to train the data model may preferably be obtained from historical in-field assessments of Sclerotinia sp. fungi incidence in pre-selected or randomly selected canola fields. Preferably, an obtained field condition data set includes as many field condition indicators as possible, such as indicators for a planting date, a geolocation, a crop variety, a variety and/or maturity rating, a soil texture, a tillage depth, a crop rotation history, a disease history, a row spacing, and/or a seeding rate.

The data model may be referred to as a SRA model (Sclerotinia sp. fungi Risk Assessment model, also Sclerotinia sp. fungi Risk Advisor model). The data model and/or a sub-model of the data model may include multiple parameters and/or rules. The parameters and rules within the data model and/or within each of the sub-models within the data model preferably are iteratively adjusted to maximize a correspondence of a returned model disease risk value to a reported/assessed level of historical disease incidence in the combined set of historical data sets. In addition to the disease assessment and field condition data sets, corresponding field-specific daily weather and daily crop phenology data are preferably also incorporated into the training data sets for model calibration.

According to an option, each field condition indicator of a training data set, that is used for training the model and/or at least one of the sub-models, is associated to a crop growth stage range from BBCH 60 to BBCH 79, preferably a crop growth stage range from BBCH 60 to BBCH 65 and more preferably a crop growth stage range from BBCH 62 to BBCH 65. The field condition data set in addition preferably includes at least one of the following field condition indicators: k) a precipitation indicator, I) at least one air temperature indicator, m) at least one relative humidity indicator, n) a wind speed indicator, o) a solar radiation indicator, p) a soil moisture indicator, q) a crop species indicator, r) a crop phenology indicator, s) a canopy density indicator, and/or t) a crop biomass indicator.

Especially in the case of canola, preferred BBCH stages may be defined as follows: BBCH 60 corresponds to a beginning of flowering. BBCH 61 corresponds to 10% flowering, which is sometimes referred to as early flowering. BBCH 63 corresponds to 30% flowering. BBCH 64 corresponds to 40% flowering. BBCH 65 corresponds to full flowering. BBCH 69 corresponds to end of flowering. BBCH 79 corresponds to nearly end of pod development. According to BBCH, for example 10% flowering may mean that 10% of the flowers are open.

According to an option, the structure of the data model may have at least two sub-models. Each sub-model preferably is calibrated to a crop growth stage range defined by a range start time to a range end time.

The at least two sub-models differ amongst each other preferably at least in one of the range start time and the range end time. That is, any two sub-models may wholly or partially timewise overlap with each other, be timewise consecutive to another, and/or be timewise separate from another, including the case where one sub-model reflects a timewise section of another sub-model.

The sub-models preferably model a disease risk during different phases of the Sclerotinia sp. fungi disease life cycle on canola. As such, one or more rules, one or more parameters, and/or one or more data attribute dependencies differ between different sub-models.

According to an option, each field condition indicator of a training data set, that is used for training the model and/or at least one of the sub-models, is associated to a crop growth stage range from a given timespan before BBCH 60 or from BBCH 60 to BBCH 63. In this case, the field condition data set preferably includes at least one of the following field condition indicators: k) a precipitation indicator, l) at least one air temperature indicator, m) at least one relative humidity indicator, n) a wind speed indicator, p) a soil moisture indicator, s) a canopy density indicator, and/or t) a crop biomass indicator.

When training a model and/or sub-model with field condition indicators associated to a crop growth stage range from said given timespan before BBCH 60 or from BBCH 60 to BBCH 63, then the model and/or sub-model may beneficially indicate a risk of Sclerotinia sp. fungi apothecia germination from sclerotia in the soil during a period from before a start of flowering of from a start of flowering, especially a start of flowering of Canola, through approximately BBCH growth stage 63.

Said given timespan may include one month prior to BBCH 60, preferably 28 days or four weeks prior to BBCH 60, and more preferably 21 day or three weeks prior to BBCH 60.

According to an option, each field condition indicator of a training data set, that is used for training the model and/or at least one of the sub-models, is associated to a crop growth stage range from BBCH 61 to BBCH 65. In this case, the field condition data set preferably includes at least one of the following field condition indicators: k) a precipitation indicator, l) at least one air temperature indicator, m) at least one relative humidity indicator, and/or n) a wind speed indicator. When training a model and/or sub-model with field condition indicators associated to a crop growth stage range from BBCH 61 to BBCH 65, then the model and/or a sub-model may beneficially indicate a risk of a Sclerotinia sp. fungi infection of petals, especially Canola petals, during approximate BBCH growth stages 61 through 65.

According to an option, each field condition indicator of a training data set, that is used for training the model and/or at least one of the sub-models, is associated to a crop growth stage range from BBCH 64 to BBCH 69. In this case, the field condition data set preferably includes at least one of the following field condition indicators: k) a precipitation indicator, l) at least one air temperature indicator, and/or m) at least one relative humidity indicator.

When training a model and/or sub-model with field condition indicators associated to a crop growth stage range from BBCH 64 to BBCH 69, then the model and/or sub-model may beneficially indicate a risk of a Sclerotinia sp. fungi infection initiation on leaves and/or stems, especially on Canola leaves and/or stems, during said BBCH growth stages 64 through 69.

According to an option, each field condition indicator of a training data set, that is used for training the model and/or at least one of the sub-models, is associated to a crop grow stage range from BBCH 64 to BBCH 79. In this case, the field condition data set preferably includes at least one of the following field condition data: k) a precipitation indicator, l) at least one air temperature indicator, and/or m) at least one relative humidity indicator.

When training a model and/or sub-model with field condition indicators associated to a crop growth stage range from BBCH 64 to BBCH 79, then the model and/or sub-model may beneficially indicate a risk of a Sclerotinia sp. fungi lesion development and expansion on leaves and/or stems, especially on Canola leaves and/or stems, during said BBCH growth stages 64 through 79.

According to an aspect of the invention, a device for training a data model to output a disease probability value is suggested. The disease probability value is indicative of a probability of an infestation of crop plants of a specifiable field with Sclerotinia sp. fungi, and it is being determined from a field condition data set. The suggested device includes a providing means configured for providing a program structure of a data model, which is configured to output a disease probability value determined from a field condition data set. Said disease probability value is indicative of a probability of an infestation of crop plants of a specifiable field with said Sclerotinia sp. fungi. The suggested device includes a generation means configured for generating multiple training data sets. Each training data set includes one field condition data set and an associated disease indication probability value. Each field condition data set is indicative of a condition of a specifiable field. Each field condition data set includes at least one of the following field condition indicators: a) a seeding rate indicator, b) a tillage depth indicator, c) a disease history indicator, d) a crop rotation history indicator, e) a planting date indicator, and/or f) a field geolocation indicator. The suggested method includes a training means configured for training the data model by processing the generated training data sets, wherein a match between a disease probability value outputted in response to a query and the disease indication probability value associated with the queried field condition data set is used as a training objective. This device incorporates the features of the above method for training a data model, and thus has its advantages.

According to an aspect of the invention, a trained data model is suggested. The trained data model is obtainable by performing the method for training a data model as given above. The trained data model preferably is configured to output a disease probability value determined from a field condition data set. The trained data model may be obtained by calibrating sub-model parameters. Such a calibration may be provided from applying a best-fit algorithm to historical field condition data. As a result from the field condition data sets used to train the data model and usable for determining the disease probability value, the data model is configured for assessing a risk of a Sclerotinia sp. fungi infection to a specific field-thus it is a means for improved Sclerotinia sp. fungi risk assessment.

According to another aspect of the invention, a use of such a trained data model is suggested for outputting and/or determining a disease probability value indicative of a probability of an infestation of crop plants of a specifiable field with Sclerotinia sp. fungi. Thus, for the same rea-sons as stated above regarding the trained data model, this use is a means for improved Sclerotinia sp. fungi risk assessment.

The invention also refers to the data sets used for training the data model and/or for determining the disease probability value. That is, according to another aspect of the invention, a field condition data set is suggested. The suggested field condition data set is indicative of a condition of a specifiable field. The suggested field condition data set includes at least one of the following field condition indicators: a) a seeding rate indicator, b) a tillage depth indicator, c) a disease history indicator, d) a crop rotation history indicator, e) a planting date indicator, and/or f) a field geolocation indicator. The suggested field condition data set preferably includes additionally at least one of the following field condition indicators: g) a row spacing indicator, h) a soil texture indicator, i) a crop varietal indicator, k) a precipitation indicator, l) at least one air temperature indicator, m) at least one relative humidity indicator, n) a wind speed indicator, o) a solar radiation indicator indicative of a solar radiation flux of the field on a daily basis, p) a soil moisture indicator, q) a crop species indicator, r) a crop phenology indicator, s) a canopy density indicator, and/or t) a crop biomass indicator. This field condition data set is suitable for predicting a risk of a specific field being infected with Sclerotinia sp. fungi. Vice versa, this field condition data set is also suitable for training an according data model.

According to an aspect of the invention, a training data set for training a data model for determining a disease probability value indicative of a risk of an infection with Sclerotinia sp. fungi is suggested. The suggested training data set includes one of said field condition data sets and an associated disease indication probability value. Optionally, said disease indication probability value may include an expert annotated historical data indicative of a previous infection of crop plants on the field with Sclerotinia sp. fungi. Optionally, said disease indication probability value may include a historical damage data preferably based on sensor readings.

According to an aspect of the invention, a method for generating a field condition data set suitable for field-specific determination of a disease probability value indicative of a risk of an infection with Sclerotinia sp. fungi for crop plants of the specific field is suggested. The suggested method includes determining at least one of the following field condition indicators: a) a seeding rate indicator, b) a tillage depth indicator, c) a disease history indicator, d) a crop rotation history indicator, e) a planting date indicator, and/or f) a field geolocation indicator. The suggested method preferably includes additionally determining at least one of the following field condition indicators: g) a row spacing indicator, h) a soil texture indicator, i) a crop varietal indicator, k) a precipitation indicator, l) at least one air temperature indicator, m) at least one relative humidity indicator, n) a wind speed indicator, o) a solar radiation indicator, p) a soil moisture indicator, q) a crop species indicator, r) a crop phenology indicator, s) a canopy density indicator, and/or t) a crop biomass indicator. The suggested method includes compiling the determined field condition indicators into a field condition data set. Thus, input data for precise Sclerotinia sp. fungi risk assessment and/or for training a data model therefore can be obtained.

According to an aspect of the invention, a method for generating a training data set is suggested. This suggested method includes the above method for generating a field condition data set. The suggested method further includes determining a disease indication probability value, that is associated with each field condition indicator determined during this method. The suggested method further includes compiling the field condition data set and/or the determined field condition indicators together with the determined disease indication probability value into a training data set. Thus, a data model can be trained for field-specific Sclerotinia sp. fungi risk assessment.

According to another aspect of the invention, a use of the above field condition data set is suggested for training a data model to output a disease probability value, that is indicative of a probability of an infestation of crop plants of a specifiable field with Sclerotinia sp. fungi, and/or for determining a disease probability value, that is indicative of a probability of an infestation of crop plants of a specifiable field with said Sclerotinia sp. fungi, from a trained data model. Since the field condition data set is suitable for field-specific Sclerotinia sp. fungi risk assessment, it is advantageous to use it for training a data model and for determining an infection probability value.

According to another aspect of the invention, a method for determining a disease probability value, that is indicative of a probability of an infestation of crop plants of a specifiable field with Sclerotinia sp. fungi, is suggested. The suggested method includes generating a field condition data set indicative of a condition of a specifiable field. A field condition data set includes at least one of the following field condition indicators: a) a seeding rate indicator, b) a tillage depth indicator, c) a disease history indicator, d) a crop rotation history indicator, e) a planting date indicator, and/or f) a field geolocation indicator. The suggested method includes providing a trained data model, which is configured to output a disease probability value determined from a field condition data set, wherein said disease probability value is indicative of a probability of an infestation of a crop plant with said Sclerotinia sp. fungi. The data model is obtainable by previous training with multiple training data sets, each training data set including one of said field condition data sets and an associated disease indication probability value. The suggested method includes determining by the data model a disease probability value from the generated field condition data set. Mainly due to the selected field condition indicators, the method is suitable for precisely determining a risk of a specific field being infected with Sclerotinia sp. fungi. Preferably, the above method further includes returning, sending, and/or outputting the determined disease probability value to a control device interface and/or to an end-user device interface. The suggested method may be performed by a user to decide upon an application action before manually initiating an application of the plant protecting agent.

According to a further aspect of the invention, a method for determining an amount of a plant protecting agent to be applied on at least one field from a list of fields is suggested. The suggested method includes providing a list of specific fields. This suggested method includes performing the above method for determining a disease probability value for each field specified in the list. The suggested method further includes determining an amount of a plant protecting agent based on an area of each specific field from the above list, that is associated with a disease probability value exceeding a pre-set threshold value. This suggested method may thus be used for automated ordering of a plant protection agent, for example via a smartphone app.

Thus, a user is able to precisely order a needed amount of a plant protecting agent, which renders this suggested method very cost-efficient.

According to an aspect of the invention, a method for generating instruction data for assisting an operator of a human steered agricultural machine is suggested. This suggested method includes the above method for determining a disease probability value for each field specified in the list. The suggested method further includes generating instruction data. Said instruction data may preferably be indicative of the determined disease probability value exceeding a pre-set threshold value if the determined disease probability value exceeds the pre-set threshold value. Said instruction data may preferably be indicative of an application action of applying a plant protecting agent, which is determined based on said determined disease probability value.

According to an aspect of the invention, a method for generating control data for an application device is suggested, which application device is configured for applying a plant protecting agent to a specific field. This suggested method includes the above method for determining a disease probability value for a specific field, to which field at least one application device is associated. The method includes providing an amount of the plant protecting agent for each of the at least one application devices, which amount is dimensioned for at least one application by the associated application device over a whole area reachable by the associated application device. The suggested method includes applying the plant protecting agent in the case that the determined disease probability value exceeds a pre-set threshold value. This method has the advantage of being able to immediately apply the plant protecting agent by the application device when a high risk of Sclerotinia sp. fungi infection is determined. The application device preferably is a fungicide sprayer device.

According to an aspect of the invention, a method for generating control data for controlling an agricultural robot is suggested. This suggested method includes the above method for determining a disease probability value for a specific field. The suggested method includes generating control data configured for controlling an agricultural robot. Said generating the control data may include generating a route indicator indicative of a route and/or a trajectory to be followed by the agricultural robot based on a list of specific fields and a determined disease probability value associated with each field, wherein preferably the route includes those fields, of which fields the associated disease probability value exceeds a pre-set threshold value. Said generating the control data may include generating application data indicative of an application action for applying a plant protecting agent based on a determined disease probability value associated with a specifiable field.

According to an aspect of the invention, a device for determining an amount of a plant protecting agent to be applied on at least one field from a pre-set list of fields is suggested. Said device has a generation means configured for generating a field condition data set, which includes at least one of the following field condition indicators: a) a seeding rate indicator, b) a tillage depth indicator, c) a disease history indicator, d) a crop rotation history indicator, e) a planting date indicator, and/or f) a field geolocation indicator. Optionally, said generated field condition data set may additionally include at least one of the following field condition indicators: g) a row spacing indicator, h) a soil texture indicator, i) a crop varietal indicator, k) a precipitation indicator, l) at least one air temperature indicator, m) at least one relative humidity indicator, n) a wind speed indicator, o) a solar radiation indicator, p) a soil moisture indicator, q) a crop species indicator, r) a crop phenology indicator, s) a canopy density indicator, and/or t) a crop biomass indicator. The suggested device includes a data model providing means configured for providing a trained data model. The suggested device includes a determination means configured for determining by the data model a disease probability value from the generated field condition data set. This device incorporates the features of the above method for autonomous application of a plant protecting agent, and thus has its advantages.

According to an aspect of the invention, a computer program and/or a computer-program product is suggested. The suggested computer product and/or computer-program product comprises a program code for executing any of the above methods by a computerized control device when run on at least one computerized device. A computer program product, such as a computer program means, may be embodied as a memory card, USB stick, CD-ROM, DVD, another data storage device, or as a file which may be downloaded from a server in a network. For example, such a file may be provided by transferring the file comprising the computer program product from a wireless communication network.

According to a further aspect, a computer-readable medium is suggested. The suggested computer-readable medium stores computer program instructions, wherein the computer program instructions, when executed by a computerized device, cause the computerized device to perform operations comprising any of the above methods. The computer-readable medium is, in particular, a non-transitory computer-readable medium.

The above methods and/or devices are intended to preferably cooperate and/or be integrated into a same system for preventing crop of a specifiable field being infected with Sclerotinia sp. fungi. Thus, features provided for one method, device, data model, use, data set, program, medium, and/or option thereof are applicable also for every other method, device, data model, use, data set, program, medium, and/or option thereof even when it is not explicitly mentioned. Further possible implementations or alternative solutions of the invention also encompass combinations—that are not explicitly mentioned herein—of features described above or below in regard to the embodiments. The person skilled in the art may also add individual or isolated aspects and features to the most basic form of the invention.

In fewer words, a method for determining a disease probability value is suggested, that is indicative of a probability of an infestation of crop plants of a specifiable field with Sclerotinia sp. fungi, including: generating a field condition data set indicative of a condition of a specifiable field, including at least one of: a row spacing indicator, a seeding rate indicator, a tillage depth indicator, a soil texture indicator, a crop varietal indicator, a disease history indicator, a crop rotation history indicator, a planting date indicator, and/or a field geolocation indicator; providing a trained data model configured to output a disease probability value determined from a field condition data set and indicative of a probability of an infestation of crop plants with Sclerotinia sp. fungi; and determining by the data model a disease probability value from the generated field condition data set.

Further embodiments, features and advantages of the present invention will become apparent from the subsequent description and dependent claims, taken in conjunction with the accompanying drawings, in which:

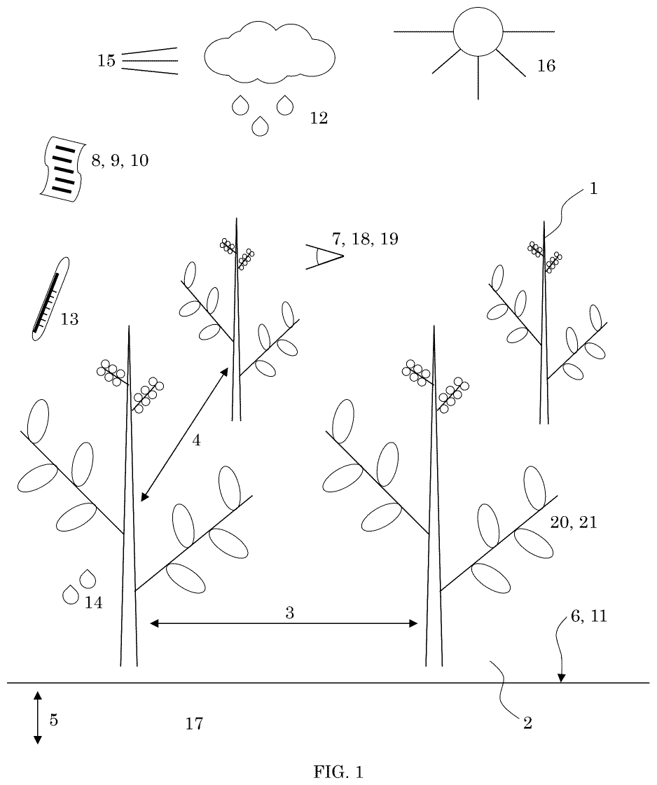

FIG. 1 schematically shows a specific field, on which canola plants are growing, illustrating a computer-implemented method for generating a field condition data set according to an embodiment of the invention,

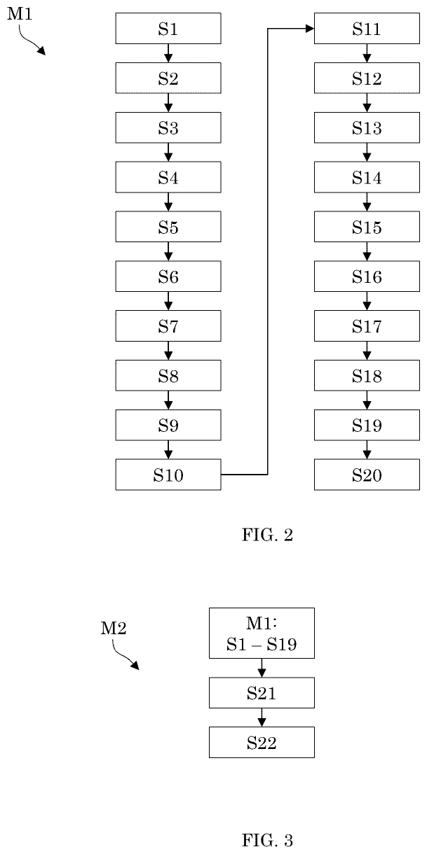

FIG. 2 schematically shows a flow diagram of said method for generating a field condition data set,

FIG. 3 schematically shows a flow diagram of a computer-implemented method for generating a training data set,

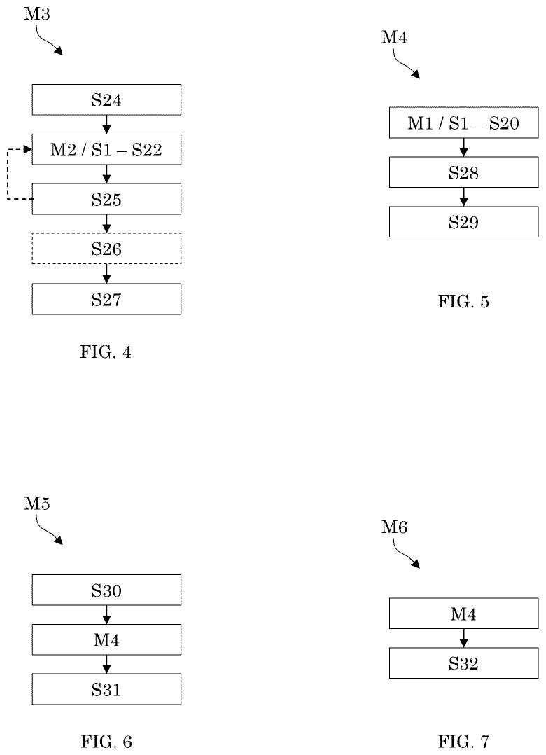

FIG. 4 schematically shows a flow diagram of a computer-implemented method for training a data model to output a disease probability value,

FIG. 5 schematically shows a flow diagram of a computer-implemented method for determining a disease probability value,

FIG. 6 schematically shows a flow diagram of a computer-implemented method for determining an amount of a plant protecting agent to be applied on at least one field, and

FIG. 7 schematically shows a flow diagram of a computer-implemented method for autonomous application of a plant protecting agent.

In the Figures, like reference numerals designate like or functionally equivalent elements, unless otherwise indicated.

First, a method M1 for generating a field condition data set is presented with reference to FIGS. 1 and 2. The field condition data set is suitable for field-specific determination of a disease probability value indicative of a risk of an infection with Sclerotinia sp. fungi for crop plants 1 of a 16 specific field 2. Performing the method M1 generates a data set, which is indicative of or represents a condition of the crop plants 1 on the specific field 2. The crop plants 1 in this example are canola plants. Not all steps shown in this illustrative embodiment are necessary.

In a first step S1, a row spacing indicator is determined. The row spacing indicator is indicative or represents a crop row spacing 3 between each two adjacent rows of crop plants 1. As a planting machine will usually be used, the crop row spacing 3 will be constant in most cases throughout the specific field 2. Preferably, a crop row spacing 3 set by the planting machine may be used. Preferably, an average and/or median value is used. However, it shall be noticed that the row spacing indicator is indicative of the crop row spacing 3, but the indicator must not necessarily be the value of the spacing.

In a next step S2, a seeding rate indicator is determined. The seeding rate indicator is indicative of a distance 4 between each two adjacent crop plants 1 within a row of the specific field 2. As a planting machine will usually be used, the seeding rate will be constant throughout the specific field 2 in most cases. Preferably, an average value and/or a median value is used In a next step S3, a tillage depth indicator is determined. The tillage depth indicator represents a depth 5 of a tillage of the specific field 2.

In a next step S4, a soil texture indicator is determined. The soil texture indicator represents a texture 6 of a soil of the specific field. The soil texture indicator may for example be indicative of a roughness, a grain size, and/or the like of the soil, preferably of the soil surface. Preferably, the soil texture indicator is determined on a daily basis.

In a next step S5, a crop varietal indicator is determined. The crop varietal indicator represents a variety and/or a maturity rating 7 of the crop plants 1 of the specific field 2. Step S5 is preferably performed at a time of seeding.

In a next step S6, a disease history indicator is determined. The disease history indicator represents a disease history 8 of none to several infections with Sclerotinia sp. fungi of crop plants 1 at this specific field 2 in previous seasons/years. As spores of Sclerotinia sp. fungi can survive in the soil for several years, determining this indicator can increase prediction reliability. The disease history indicator preferably is indicative of when at least the most recent infection with Sclerotinia sp. fungi happened, and preferably it is indicative of when each infection with Sclerotinia sp. fungi happened.

In a next step S7, a crop history indicator is determined. The crop history indicator represents a crop rotation history 9 of crop rotation performed at this specific field 2.

In a next step S8, a planting date indicator is determined. The planting date indicator represents a date 10 on which the crop plants 1 were planted on the specific field 2. The planting date indicator preferably indicates the day of the year or season. The planting date indicator preferably also indicates the year of planting.

In a next step S9, a field geolocation indicator is determined. The field geolocation indicator represents a centroid coordinate 11 of the specific field 2.

At least one of the steps S1 to S9 is performed according to the invention, wherein it is preferred to perform all nine steps for increased precision in assessing the risk of an infestation of Sclerotinia sp. fungi. If step S9 is performed, then the specific field 2 is specified. Even if step S9 is not performed, then the specific field 2 is specifiable as it is known to a user.

In a next step S10, a precipitation indicator is determined. The precipitation indicator represents an amount of liquid accumulation 12, such as rainfall and condensation, at the specific field 2.

The amount preferably relates to a standard area, such as liquid accumulation per square meter or liquid accumulation per square foot and the like. The liquid accumulation is preferably determined on a daily basis.

In a next step S11, at least one air temperature indicator is determined. The air temperature indicator represents at least one characteristic air temperature value 13 of a daily air temperature course. For example, the air temperature indicator may represent a daily minimal temperature, a daily average temperature, a daily median temperature, a daily maximal temperature, a daily temperature spread, and/or the like. The air temperature indicator may represent a characteristic value 13 that is measurable at the same time each day, like a temperature at noon, a temperature at sunset, a temperature at a pre-set time, and/or the like.

In a next step S12, at least one relative humidity indicator is determined, which represents a characteristic humidity value 14 of a daily course of relative humidity. For example, the relative humidity indicator may represent a daily minimal relative humidity, a daily average relative humidity, a daily median relative humidity, a daily maximal relative humidity, a daily relative humidity spread, and/or the like. The relative humidity indicator may represent a characteristic humidity value 14 that is measurable at the same time each day, like a relative humidity at noon, a relative humidity at sunset, a relative humidity at a pre-set time, and/or the like.

In a next step S13, a wind speed indicator is determined. The wind speed indicator represents an average wind speed 15 at the specific field 2 on a daily basis. As Sclerotinia sp. fungi apothecia release spores, which are then blown to petals, the daily wind speed average may be an impactful indicator in predicting a Sclerotinia sp. fungi infection risk.

In a next step S14, a solar radiation indicator is determined. The solar radiation indicator represents a solar radiation flux 16 onto the specific field 2. The solar radiation indicator is preferably determined on a daily basis.

In a next step S15, a soil moisture indicator is determined. The soil moisture indicator represents a moisture 17 or water content within an upper layer of the specific field 2. The soil moisture is preferably determined on a daily basis.

In a next step S16, a crop species indicator is determined. The crop species indicator represents a species 18 of the crop plants 1 growing in this season/year on the specific field 2.

In a next step S17, a crop phenology indicator is determined. The crop phenology indicator represents a growth stage 19 of the crop plants 1. The crop phenology indicator preferably is based on a phenology model, such as the Xarvio phenology model. This is advantageous for performing the method without a specific training to a user. The growth stage 19 is determined on a daily basis.

In a next step S18, a canopy density indicator is determined. The canopy density indicator represents a canopy density 20 of a canopy formed by leaves of the plants on the specific field 2. The canopy density indicator is preferably determined on a daily basis.

In a next step S19, a crop biomass indicator is determined. The crop biomass indicator represents a stand density 21 of the plants, especially the crop plants 1, on the specific field 2. The crop biomass indicator is preferably determined on a daily basis.

Any of the above indicators may for example be a precise value, a class associated with the precise value within a classification, and/or a code representative of the precise value or its class.

In a next step S20, a field condition data set is generated. The field condition indicators determined in steps S1 to S19 may preferably be compiled together, thereby forming the field condition data set.

Then, the method M1 is ended. The generated field condition data set can be used for precisely determining a disease probability value of said crop plants 1 on the specific field 2 on a daily basis.

Next, a method M2 for generating a training data set for training a data model for outputting a disease probability value, the disease probability value being indicative of a probability of an infestation of crop plants of a specifiable field with Sclerotinia sp. fungi is presented in connection with FIG. 3.

The method M2 includes at least one of the above steps S1 to S9. Preferably, the method M2 includes any of steps S1 to S19. The method M2 may also include the complete method M1. When generating training data, one or preferably more field condition indicator(s), each representative of a historical field condition, are determined.

In a next step S21, a disease indication probability value is determined. The disease indication probability value represents a historical disease indication.

In a next step S22, the field condition indicator(s) and the disease indication probability value are compiled into a training data set, which thereby is generated. Preferably, the field condition data set containing said field condition indicator(s) is compiled with the disease probability indication value into the training data set.

In most cases, the disease indication will be determined at a later stage during the earlier season, such that there is a high confidence in the disease indication. In order to train the data model to precisely assess an infection risk during early stages of flowering, such as up to BBCH 65 and preferably up to BBCH 63, it is preferred to combine historical field condition indicators corresponding to said early flowering stages with associated historical disease indications corresponding to late growth stages during the respective season and/or year. This can easily be done by protocolling the field condition indicators during the course of a year and performing the method M2 afterwards.

Next, a method M3 for training a data model to output a disease probability value will be explained with reference to FIG. 4.

First, in a step S24, a program structure of a data model is provided. This includes the case where a pre-training data model or “empty data model” is provided. This also includes the case where an already trained data model is provided for further training.

Then the method M2 for generating training data is performed multiple times, thereby generating multiple training data sets.

In a next step S25, the data model is trained with the generated training data sets. During said training, a match between a disease indication probability value and a disease probability value determined from a field condition data set associated to this disease indication probability value is used as a training objective. In other words, the data model is trained to predict disease probability values that have a minimal or no difference to disease indication probability values.

Then, in a next step S27, the trained data model is provided. For example, the trained data model may be stored in a database and/or be made available via a network, preferably via the internet.

Now, a variation of the method M3 will be explained by reference to the same FIG. 4. In this variation, at least two sub-models are trained. Each sub-model is trained for determining a risk of Sclerotinia sp. fungi infection within one specific growth phase. Thus, method M2 and step 25 are performed two or more times.

First, a sub-model is trained for a growth phase of canola plants 1, which growth phase ranges from 21 days prior to flowering at BBCH 60 to BBCH 63, which corresponds to 30% flowering. Thus, field condition data sets are prepared with historical field conditions previously collected indicative of this specific growth phase. It may be advantageous to additionally include historical field conditions previously collected indicative of phases before and after the specific growth phase for increased interpolation smoothness. Preferably, at least 30%, more preferably at least 50%, more preferably 75%, and more preferably 100% of the field condition data sets generated in method M2 and used for training of the sub-model in S25 are collected indicative of this specific growth phase. In other words, these at least 30%, 50%, 75%, or even 100% of the data sets represent field conditions recorded or recordable during the growth phase from three weeks before BBCH 60 to BBCH 63.

To collect historical field conditions indicative of a given growth phase may for example include to determine a soil moisture within this growth phase and to determine a row spacing anytime. The reason is that a row spacing in most cases will not alter during a season, while a soil moisture will probably vary from day to day.

The inventors have found that this sub-model, which is configured for assessing a Sclerotinia sp. fungi infestation risk from 21 days prior to flowering to BBCH 63, is advantageously trained including the daily precipitation indicator, one or more daily air temperature indicators, one or more daily humidity indicators, the daily wind speed indicator, the daily soil moisture indicator, the daily canopy density indicator, and/or the daily crop biomass indicator. Including these field condition indicators into the field condition data sets has proven to provide very good Sclerotinia sp. fungi infection predictions for this growth period.

Next, a sub-model is trained for a growth phase of canola plants, which growth phase ranges from BBCH 61 to BBCH 65, which corresponds to 10% flowering to full flowering. The inventors have found that this sub-model is advantageously trained including the daily precipitation indicator, one or more daily air temperature indicators, one or more daily humidity indicators, and/or the daily wind speed indicator.

The two sub-models above are preferred, as they correlate with effective application of current fungicides.

Next, a sub-model is trained for a growth phase of canola plants, which growth phase ranges from BBCH 64 to BBCH 69, which corresponds to 40% flowering to end of flowering. The inventors have found that this sub-model is advantageously trained including the daily precipitation indicator, one or more daily air temperature indicators, and/or one or more daily humidity indicators.

Next, a sub-model is trained for a growth phase of canola plants, which growth phase ranges from BBCH 64 to BBCH 79, which corresponds to 40% flowering to nearly end of pod development. The inventors have found that this sub-model is advantageously trained including the daily precipitation indicator, one or more daily air temperature indicators, and/or one or more daily humidity indicators.

Then, the sub-models are optionally compiled to a single data model in step S26 for improved handling.

Next will be explained a method M4 for determining a disease probability value, which is indicative of a probability of an infestation of crop plants 1 of a specific field 2 with Sclerotinia sp. fungi. The method M4 is shown in the flow diagram of FIG. 5.

First there is a step of generating a field condition data set, which is indicative of a condition of the specific field 2. This step is performed by performing the above method M1 and/or the steps S1 to S20. In a minimal configuration, at least one of the steps S1 to S9 is performed.

Next, a trained data model is provided in a step S28. This may for example include the trained data set being retrieved from a storage and/or being available via a network. The trained data model is preferably obtained by the above method M3.

Next is a step S29 of determining a disease probability value. In this step, the field condition data set generated before in S1 to S9, preferably in M1, is input to the trained data model provided in S28. This may be in the form of a query. Then, a response from the data model is received including the disease probability value indicative of a probability of an infestation of crop plants 1 of a specific field 2 with Sclerotinia sp. fungi.

Thus, the method M4 is suitable and configured for determining and assessing a Sclerotinia sp. fungi risk individually for a specific field 2 and on a daily basis.

Now, a method M5 for determining an amount of a plant protecting agent to be applied on at least one field 2 from a list of fields 2 is presented, a flow diagram of which is illustrated in FIG. 6.

First, in a step S30, a list of specific fields 2 is provided. This may include generating the list of fields 2. However, in many cases a user will already have the list available in some sort, for example from a previous year.

Then, the above method M4 for determining a disease probability value is performed for each of the fields 2 from the list of fields 2 provided in S30. Thus, a disease probability value is determined, which is individual and specific for each specific field 2. In most cases, the disease probability value will be different for each of the fields 2.

In a next step S31, an amount of a plant protecting agent is determined based on an area of each specific field 2 from the above list, that is associated with a disease probability value exceeding a pre-set threshold value. That is, an area of each field 2 from the list or at least an area of each field 2, for which a high risk of a Sclerotinia sp. fungi infection is determined, is provided. A “high” risk of a Sclerotinia sp. fungi infection preferably is determined by comparing the determined disease probability value to a pre-set threshold value.

Next, a method M6 for autonomous application of a plant protecting agent for reducing and/or preventing a damage by Sclerotinia sp. fungi to crop plants 1 of a specific field 2 is presented with reference to FIG. 7.

### First, the Steps S1 to S20, S28, and S29 of Above-explained Method M4 Are Performed.

Next is a step S32 of initiating an application of a plant protecting agent based on a determined disease probability value to the specific field 2 by an autonomously moveable robot.

Step S32 may include providing the robot with an identifier indicative of the specific filed 2. Step S32 may include generating a trajectory for the robot, which is to be autonomously followed by the self-moveable robot. Step S32 may include generating an application sequence for the robot that is instructive to an application scheme to be followed by the robot during application of the plant protecting agent.

Thus, the method M6 combines the advantages of an improved Sclerotinia sp. fungi risk assessment with the possibility of a fast reaction to a high risk of an infection with Sclerotinia sp. fungi.

### REFERENCE SIGNS

1 crop plant
2 specific field
3 crop row spacing
4 distance between crop plants within a row
5 depth of tillage
6 soil texture
7 variety and/or maturity rating of crop plants
8 disease history
9 crop rotation history
10 planting date
11 centroid coordinate
12 liquid accumulation
13 characteristic value of daily air temperature course
14 characteristic value of daily relative humidity course
15 average wind speed
16 solar radiation flux
17 upper layer moisture
18 crop plants species
19 growth stage
20 canopy density
21 stand density
M1 method for generating a field condition data set
M2 method for generating a training data set
M3 method for training a data model to output a disease probability value
M4 method for determining a disease probability value
M5 method for an amount of a plant protecting agent
M6 method for autonomous application of a plant protecting agent
S1 determining a row spacing indicator
S2 determining a seeding rate indicator
S3 determining a tillage depth indicator
S4 determining a soil texture indicator
S5 determining a crop varietal indicator
S6 determining a disease history indicator
S7 determining a crop rotation history indicator
S8 determining a planting date indicator
S9 determining a field geolocation indicator
S10 determining a precipitation indicator
S11 determining an air temperature indicator
S12 determining a relative humidity indicator
S13 determining a wind speed indicator
S14 determining a solar radiation indicator
S15 determining a soil moisture indicator
S16 determining crop species indicator
S17 determining a crop phenology indicator
S18 determining a canopy density indicator
S19 determining a crop biomass indicator
S20 generating a field condition data set
S21 determining a disease indication probability value
S22 generating a training data set
S24 providing a program structure of a data model
S25 training a model and/or sub-model with multiple training data sets
S26 compiling multiple sub-models into a data model
S27 providing a trained data model
S28 providing a trained data model
S29 determining a disease probability value from a trained data model based on a field condition data set
S30 providing a list of specific fields
S31 determining an amount of a plant protecting agent
S32 initiating an application of a plant protecting agent based on a determined disease probability value

1. A computer-implemented method for autonomous application of a plant protecting agent for reducing and/or preventing a damage by Sclerotinia sp. fungi to crop plants of a specifiable field, the method comprising:
generating a field condition data set indicative of a condition of the specifiable field, wherein a field condition data set comprises at least one of the following field condition indicators:
a) a seeding rate indicator indicative of a seeding rate of the field,
b) a tillage depth indicator indicative of a tillage depth of the field,
c) a disease history indicator indicative of a history of said Sclerotinia sp. fungi of the field,
d) a crop rotation history indicator indicative of a crop rotation history of the field,
e) a planting date indicator indicative of a planting date of the field, and/or
f) a field geolocation indicator indicative of centroid coordinates of the field;
providing a trained data model, which is configured to output a disease probability value determined from a field condition data set, wherein said disease probability value is indicative of a probability of an infestation of crop plants of a specifiable field with said Sclerotinia sp. fungi,
wherein the data model is obtainable by previous training with multiple training data sets, each training data set including one of said field condition data sets and an associated disease indication probability value;
determining by the data model a disease probability value from the generated field condition data set; and
initiating based on the determined disease probability value an application of the plant protecting agent to said field by an autonomously movable robot.

2. The method according to claim 1, wherein said generated field condition data set further comprises at least one of the following field condition indicators:
g) a row spacing indicator indicative of a crop row spacing of the field,
h) a soil texture indicator indicative of a soil texture of the field,
i) a crop varietal indicator indicative of a variety and/or maturity rating of the crop plants of the field,
k) a precipitation indicator indicative of a liquid accumulation of the field on a daily basis,
l) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis,
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis,
n) a wind speed indicator indicative of an average wind speed of the field on a daily basis,
o) a solar radiation indicator indicative of a solar radiation flux of the field on a daily basis,
p) a soil moisture indicator indicative of a moisture in an upper soil layer of the field on a daily basis,
q) a crop species indicator indicative of a current crop species of the field,
r) a crop phenology indicator indicative of a growth stage according to a phenology model of the crop plants of the field on a daily basis,
s) a canopy density indicator indicative of a canopy density of the field, and/or
t) a crop biomass indicator indicative of a stand density of the field.

3. The method according to claim 2, further comprising requesting and receiving at least one of the field condition indicators k) to p) from at least one in-field sensor, from a remote sensing imagery and/or via a network from a data provider.

4. A computer-implemented method for training a data model to output a disease probability value, the disease probability value being indicative of a probability of an infestation of crop plants of a specifiable field with Sclerotinia sp. fungi and being determined from a field condition data set, comprising the steps:
providing program structure of a data model configured to output a disease probability value determined from a field condition data set, wherein said disease probability value is indicative of a probability of an infestation of crop plants of a specifiable field with said Sclerotinia sp. fungi;
generating multiple training data sets, each training data set including one field condition data set and an associated disease indication probability value, wherein each field condition data set is indicative of a condition of a specifiable field and comprises at least one of the following field condition indicators:
a) a seeding rate indicator indicative of a seeding rate of the field,
b) a tillage depth indicator indicative of a tillage depth of the field,
c) a disease history indicator indicative of a history of said Sclerotinia sp. fungi of the field,
d) a crop rotation history indicator indicative of a crop rotation history of the field,
e) a planting date indicator indicative of a planting date of the field, and/or
f) a field geolocation indicator indicative of centroid coordinates of the field;
training the data model by processing the generated training data sets, wherein a match between a disease probability value outputted in response to a query and the disease indication probability value associated with the queried field condition data set is used as a training objective.

5. The method according to claim 4, wherein the structure of the data model has at least two sub-models, wherein each sub-model is calibrated to a crop growth stage range defined by a range start time to a range end time.

6. The method according to claim 4, wherein each field condition indicator of a training data set, that is used for training the model and/or at least one of the sub-models, is associated to a crop growth stage range from a given timespan before BBCH 60 or from BBCH 60 to BBCH 63, wherein the field condition data set comprises at least one of the following field condition indicators:
k) a precipitation indicator indicative of a liquid accumulation of the field on a daily basis,
l) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis,
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis,
n) a wind speed indicator indicative of an average wind speed of the field on a daily basis,
p) a soil moisture indicator indicative of a moisture in an upper soil layer of the field on a daily basis,
s) a canopy density indicator indicative of a canopy density of the field, and/or
t) a crop biomass indicator indicative of a stand density of the field

7. The method according to claim 4, wherein each field condition indicator of a training data set, that is used for training the model and/or at least one of the sub-models, is associated to a crop growth stage range from BBCH 61 to BBCH 65, wherein the field condition data set comprises at least one of the following field condition indicators:
k) a precipitation indicator indicative of a liquid accumulation of the field on a daily basis,
l) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis,
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis, and/or
n) a wind speed indicator indicative of an average wind speed of the field on a daily basis.

8. The method according to claim 4, wherein each field condition indicator of a training data set, that is used for training the model and/or at least one of the sub-models, is associated to a crop growth stage range from BBCH 64 to BBCH 69, wherein the field condition data set comprises at least one of the following field condition indicators:
k) a precipitation indicator indicative of a liquid accumulation of the field on a daily basis,
l) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis, and/or
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis.

9. The method according to claim 4, wherein each field condition indicator of a training data set, that is used for training the model and/or at least one of the sub-models, is associated to a crop grow stage from BBCH 64 to BBCH 79, wherein the field condition data set comprises at least one of the following field condition data:
k) a precipitation indicator indicative of a liquid accumulation of the field on a daily basis,
1) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis, and/or
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis.

10. A trained data model, that is obtainable by performing the method for training a data model according to claim 4.

11. A method for outputting and/or determining a disease probability value indicative of a probability of an infestation of crop plants of a specifiable field with Sclerotinia sp. Fungi comprising using the trained data model according to claim 10.

12. A field condition data set indicative of a condition of a specifiable field, wherein the field condition data set comprises at least one of the following field condition indicators:
a) a seeding rate indicator indicative of a seeding rate of the field,
b) a tillage depth indicator indicative of a tillage depth of the field,
c) a disease history indicator indicative of a history of said Sclerotinia sp. fungi of the field,
d) a crop rotation history indicator indicative of a crop rotation history of the field,
e) a planting date indicator indicative of a planting date of the field, and/or
f) a field geolocation indicator indicative of centroid coordinates of the field,
wherein the field condition data set optionally further comprises at least one of the following field condition indicators:
g) a row spacing indicator indicative of a crop row spacing of the field,
h) a soil texture indicator indicative of a soil texture of the field,
i) a crop varietal indicator indicative of a variety and/or maturity rating of the crop plants of the field,
k) a precipitation indicator indicative of a liquid accumulation of the field on a daily basis,
l) at least one air temperature indicator indicative of a characteristic value from an air temperature course of the field on a daily basis, the characteristic value optionally being a minimum air temperature of the field on a daily basis, a mean air temperature of the field on a daily basis, and/or a maximum air temperature of the field on a daily basis,
m) at least one relative humidity indicator indicative of a characteristic value from a relative humidity course of the field on a daily basis, the characteristic value optionally being a minimum relative humidity of the field on a daily basis, a mean relative humidity of the field on a daily basis, and/or a maximum relative humidity of the field on a daily basis,
n) a wind speed indicator indicative of an average wind speed of the field on a daily basis,
o) a solar radiation indicator indicative of a solar radiation flux of the field on a daily basis,
p) a soil moisture indicator indicative of a moisture in an upper soil layer of the field on a daily basis,
q) a crop species indicator indicative of a current crop species of the field,
r) a crop phenology indicator indicative of a growth stage according to a phenology model of the crop plants of the field on a daily basis,
s) a canopy density indicator indicative of a canopy density of the field, and/or
t) a crop biomass indicator indicative of a stand density of the field.

13. A method for training a data model to output a disease probability value, that is indicative of a probability of an infestation of crop plants of a specifiable field with Sclerotinia sp. fungi, and/or for determining a disease probability value, that is indicative of a probability of an infestation of crop plants of a specifiable field with said Sclerotinia sp. fungi, from a trained data model comprising using the field condition data set according to claim 12.

14. A computer-implemented method for determining a disease probability value, that is indicative of a probability of an infestation of crop plants of a specifiable field with Sclerotinia sp. fungi, comprising:
generating a field condition data set indicative of a condition of a specifiable field, wherein a field condition data set comprises at least one of the following field condition indicators:
a) a seeding rate indicator indicative of a seeding rate of the field,
b) a tillage depth indicator indicative of a tillage depth of the field,
c) a disease history indicator indicative of a history of said Sclerotinia sp. fungi of the field,
d) a crop rotation history indicator indicative of a crop rotation history of the field,
e) a planting date indicator indicative of a planting date of the field, and/or
f) a field geolocation indicator indicative of centroid coordinates of the field;
providing a trained data model, which is configured to output a disease probability value determined from a field condition data set, wherein said disease probability value is indicative of a probability of an infestation of crop plants of a specifiable field with said Sclerotinia sp. fungi,
wherein the data model is obtainable by previous training with multiple training data sets, each training data set including one of said field condition data sets and an associated disease indication probability value; and
determining by the data model a disease probability value from the generated field condition data set.

15. A computer program comprising a program code for executing the method according to claim 1 by a computerized control device when run on at least one computerized device.
